(19) United States
(12) Patent Application Publication
(10) Pub. No.: US 2026/0367847 A1
(43) Pub. Date: Nov. 19, 2026

(54) INFORMATION PROCESSING APPARATUS, INFORMATION PROCESSING SYSTEM, CONTROL METHOD FOR INFORMATION PROCESSING APPARATUS, CONTROL METHOD FOR INFORMATION PROCESSING SYSTEM, AND STORAGE MEDIUM

(71) Applicant: CANON KABUSHIKI KAISHA, Tokyo (JP)

(72) Inventors: Nobuhiro Ogawa, Chiba (JP); Ryuya Tanibe, Kanagawa (JP)

(21) Appl. No.: 19/660,523

(22) Filed: Apr. 28, 2026

(30) Foreign Application Priority Data
May 13, 2025 (JP) 2025-080610

(51) Int. Cl. G06F 3/12

(52) U.S. Cl. CPC G06F 3/1254; G06F 3/1204; G06F 3/1255; G06F 3/1285

(57) ABSTRACT

An information processing apparatus comprising: one or more memory devices that store a set of instructions; and one or more processors that execute the set of instructions to: obtain a document to be printed; extract a description regarding a print setting from the obtained document to be printed or information related to the document to be printed; determine a print setting item using the extracted description regarding a print setting; and generate a setting value for the determined print setting item using generative AI.

### BACKGROUND

### Field of the Technology

The present disclosure relates to an information processing apparatus, an information processing system, a control method for an information processing apparatus, a control method for an information processing system, and a storage medium.

### Description of the Related Art

Documents to be printed and submitted may contain descriptions regarding printing methods. For example, instructions regarding printing such as "In the case that there are descriptions on both sides, please perform duplex printing" may be described outside an entry field of an application form. In such a case, it is necessary to specify duplex printing in the print settings according to the print instructions and execute printing.

Incidentally, recently, generative AI technology has been attracting attention. By using generative AI technology, when images or prompts are input to a generative AI model as input data, products such as characters, images, and videos with a high probability of matching a "context" expressed by the input data can be obtained.

Also, Japanese Patent Laid-Open No. 2014-238730 describes a technique of registering print settings corresponding to print attributes in advance, determining print attributes from the content of a document, and applying the print settings corresponding to the print attributes to a print job.

In the technique of Japanese Patent Laid-Open No. 2014-238730, print settings for each print attribute are registered in advance. However, it is conceivable that a user does not know the content and description method of print instructions described in a document in advance. Therefore, it is difficult to register print settings corresponding to the content or description method of the print instructions in advance. Also, it is conceivable that a user may overlook a print instruction in a document. Therefore, it becomes difficult to reliably reflect a print instruction in a document in print settings.

### SUMMARY

The present disclosure enables realization of a technique capable of easily and reliably reflecting a print instruction described in a document in print settings.

One aspect of the present disclosure provides an information processing apparatus comprising: one or more memory devices that store a set of instructions; and one or more processors that execute the set of instructions to: obtain a document to be printed; extract a description regarding a print setting from the obtained document to be printed or information related to the document to be printed; determine a print setting item using the extracted description regarding a print setting; and generate a setting value for the determined print setting item using generative AI.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram of an information processing system according to an embodiment.

FIG. 2 is a hardware configuration diagram of an image output apparatus according to an embodiment.

FIG. 3 is a hardware configuration diagram of a client PC and a server PC according to an embodiment.

FIG. 4 is a functional block diagram of an information processing system according to an embodiment.

FIG. 5 is a schematic diagram of processing using generative AI according to an embodiment.

FIG. 6 is a diagram illustrating a display screen according to an embodiment.

FIG. 7 is a flowchart of processing according to an embodiment.

FIG. 8 is a diagram illustrating a display screen according to an embodiment.

FIG. 9 is a flowchart of processing according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the present specification, a printing method may be any method among methods such as an electrophotographic method, an inkjet method, and a thermal transfer method. In the present specification, "recording" (also referred to as "image formation", "printing", or "print") is not limited to a case of forming significant information such as text and figures. It shall also broadly represent cases where images, designs, patterns, or the like are formed on a recording medium, or processing of a medium is performed, regardless of whether the information is significant or insignificant, or whether it has been manifested so as to be visually perceivable by a human. Further, "recording medium (sheet)" includes not only recording paper used in a general image output apparatus but also broadly includes media capable of being conveyed, such as cloth, plastic film (OHP), metal plates, glass, ceramics, wood, and leather. Further, "ink" (also referred to as "liquid") should be interpreted broadly, similar to the definition of "recording (printing)" described above. Ink shall represent a liquid that can be used for forming an image, a design, a pattern, or the like, or for processing a recording medium, or for treatment of ink (for example, coagulation or insolubilization of a coloring agent in the ink applied to the recording medium) by being applied onto the recording medium.

### Embodiment

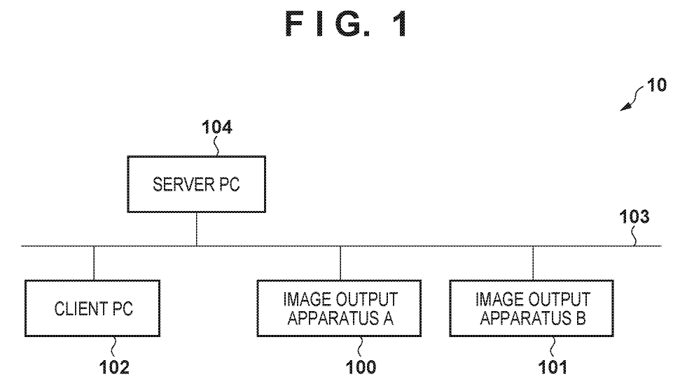

An information processing system 10 according to an embodiment will be described using FIG. 1. The information processing system 10 is, for example, a printing system targeting image output apparatuses. In the printing system, a PC connected to the image output apparatus via a network executes print job transmission to the image output apparatus. When creating a print job, editing work for print settings is performed on a screen on the PC as necessary.

More specifically, the information processing system 10 includes image output apparatuses (100, 101), a client PC 102 (an example of "another information processing apparatus"), and a server PC 104 (an example of "information processing apparatus"). Further, these apparatuses are connected to each other via a network 103.

The client PC 102 performs rendering processing on a print document (an example of "a document to be printed") and obtains a print image. Further, the client PC 102 generates a print job in which print settings are applied to the print image, and transmits the generated print job to the image output apparatuses (100, 101). When executing content analysis of the print document and generation of print settings suitable for the print document, the client PC 102 further makes a request for this processing to the server PC 104. Note that the number of image output apparatuses is not limited to two, and may be one or three or more. Further, as for the client PC and the server PC, there may be two or more of each.

Here, as an example of executing printing, a system for transmitting a print job to the image output apparatus 100 via a printer driver from a printing application installed in the client PC 102 will be described. For example, it is assumed that a printing application and a printer driver are installed in the client PC 102. The printing application obtains device information of an associated image output apparatus 100 from the printer driver, and print parameters such as paper type, paper size, and print quality. Then, the printing application can perform editing of the print settings from among the obtained parameters.

The client PC 102 configures a print job based on such print settings and the print image for which rendering processing has been completed in the client PC 102. Then, the client PC 102 transmits the print job to the image output apparatus 100 via print driver spooling to cause execution of print processing.

The image output apparatus 100 executes printing based on the print settings of the received print job. Further, the image output apparatus 100 holds, as device information, configuration information regarding consumables to be handled and status information such as an idle state and a print error. Furthermore, in a case where printing cannot be executed normally due to insufficient remaining amount of consumables, a problem with the image output apparatus, or an error in the print setting, the image output apparatus 100 presents a reason why printing cannot be performed normally to the user by displaying a warning message on a main body panel.

The server PC 104 executes content analysis of the print document and generation of print settings suitable for the print document using generative AI.

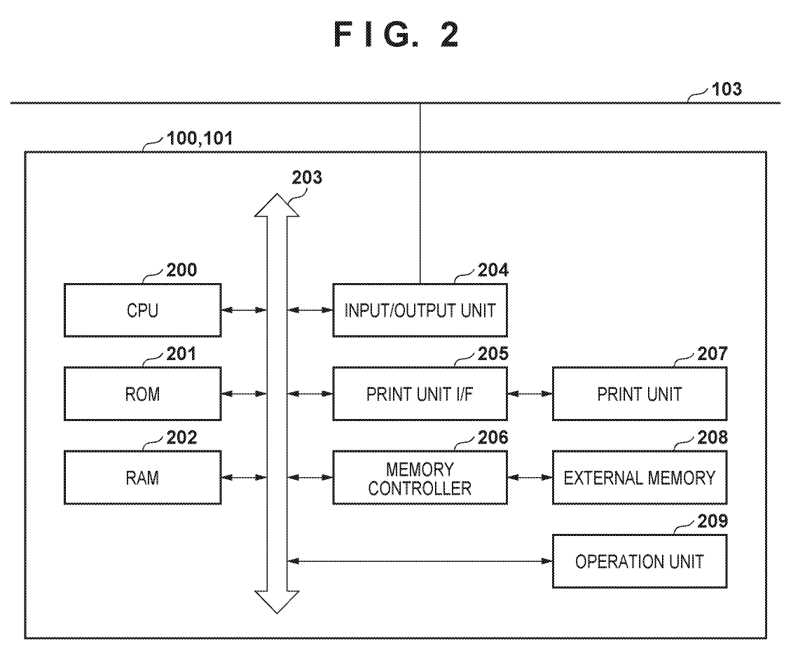

A hardware configuration of the image output apparatus 100 will be described using FIG. 2. Note that description of the image output apparatus 101 is omitted because it includes a hardware configuration similar to that of the image output apparatus 100.

The image output apparatus 100 includes a CPU 200, a ROM 201, a RAM 202, an input/output unit 204, a print unit I/F 205, a memory controller 206, a print unit 207, and an operation unit 209. Each of these configuration units is connected to each other via a data bus 203.

The CPU 200 controls each configuration unit of the image output apparatus 100 overall. The ROM 201 stores control programs and the like. The print unit I/F 205 is connected to a print unit (printer engine) 207, and outputs an image signal as output information to the print unit 207. The input/output unit 204 includes a communication module and enables communication processing between the image output apparatus 100 and the client PC 102 via the network 103. For example, the input/output unit 204 can notify the client PC 102 of information stored in the image output apparatus 100 via the network 103. Further, the input/output unit 204 can receive output data to be output to the print unit 207 via the network 103.

The RAM 202 functions as a main memory of the CPU 200, a work area, or the like, and is configured such that a memory capacity can be expanded by an optional RAM connected to an expansion port (not shown). Note that the RAM 202 is used as an output information expansion area, an environment data storage area, or a non-volatile memory or the like. The memory controller 206 controls access from the image output apparatus 100 to an external memory 208. The external memory 208 includes a hard disk (HDD), an IC card, or the like. The external memory 208 can be connected as an option, and stores control programs, font data, emulation programs, form data, remaining amounts of consumables, information regarding types and sizes of output paper, or main body status information and the like. The operation unit 209 includes, for example, a touch panel display and is capable of displaying various information and performing input operations on the displayed information. Note that the operation unit 209 may include a physical key capable of being pressed.

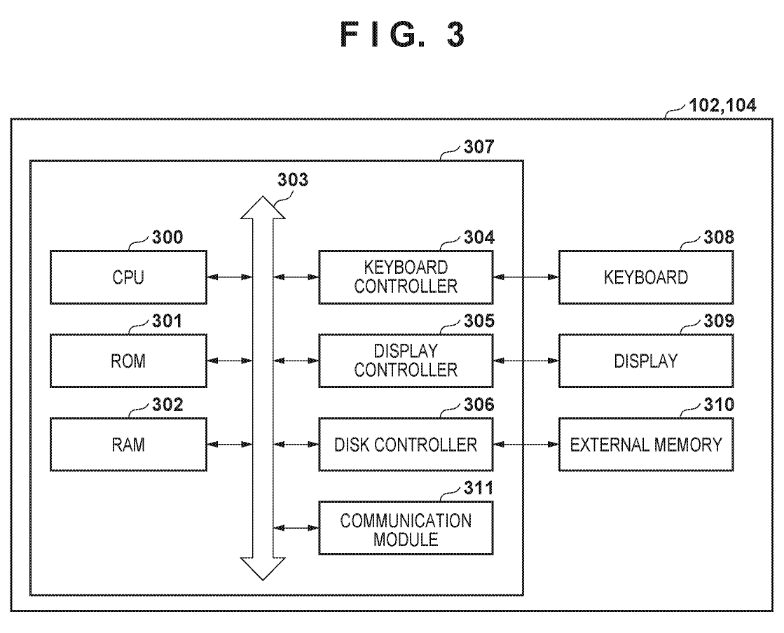

A hardware configuration of the client PC 102 and the server PC 104 will be described using FIG. 3. Note that description of the server PC 104 is omitted because it includes a hardware configuration similar to that of the client PC 102.

The client PC 102 includes, in a computer interior 307, a CPU 300, a ROM 301, a RAM 302, a keyboard controller 304, a display controller 305, a disk controller 306, and a communication module 311. Further, the client PC 102 includes a keyboard 308 and a display 309. Each of these configuration units is connected to each other via a main bus 303. Note that the keyboard 308 and the display 309 may be configured separately from the client PC 102.

The ROM 301 stores control programs and the like. The RAM 302 is configured such that its capacity can be expanded by an optional RAM or the like (not shown), and is mainly used as a work area for the CPU 300. The keyboard controller 304 controls key input from the keyboard 308 or a pointing device (not shown). The display controller 305 controls display of the display 309. The disk controller 306 controls access to an external memory 310 such as an HD, a CD-ROM, a DVD-ROM, or a USB.

The CPU 300 reads out various programs such as a control program, a system program, and an application program from the external memory 310 into the RAM 302 via the disk controller 306. The CPU 300 executes the various programs read out into the RAM 302 to perform various data processing and display control of the display 309. The CPU 300 may read out a control program or the like from the ROM 301. The CPU 300 may be a dedicated circuit such as an ASIC. The CPU 300 or the dedicated circuit is an example of a hardware circuit or a hardware processor. The communication module 311 enables communication processing among the client PC 102, the server PC 104, and the image output apparatus 100 via the network 103.

Note that in the embodiment, unless otherwise specified, the CPU 300 controls each unit connected to the main bus 303 via the main bus 303. Further, the server PC 104 may be configured without including the display 309.

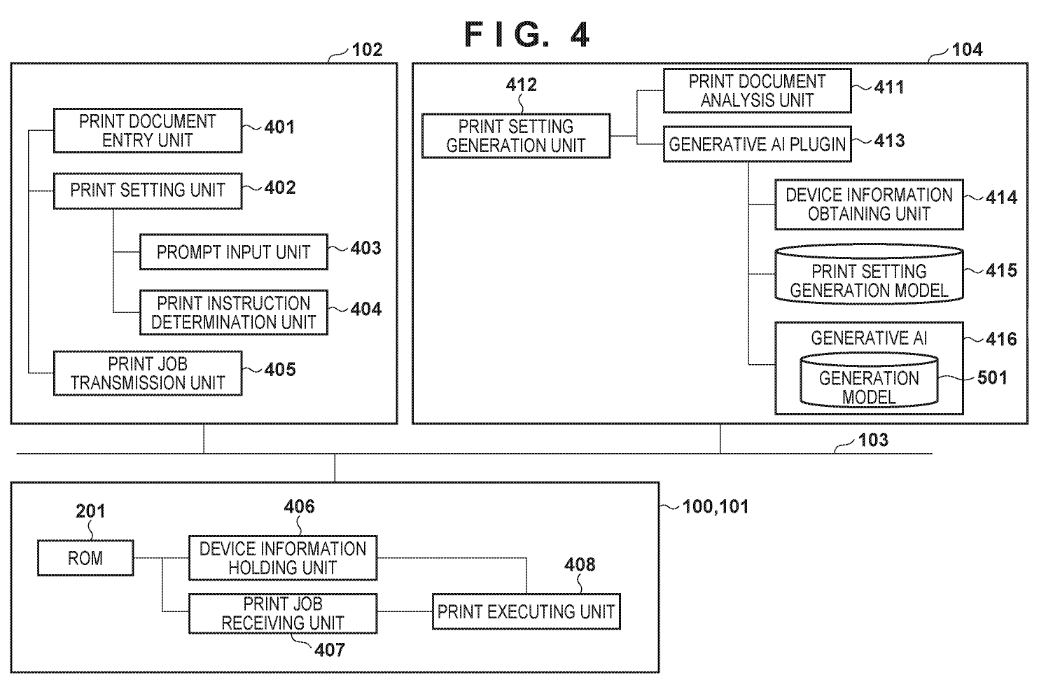

Functional blocks of each apparatus configuring the information processing system 10 will be described using FIG. 4. First, the client PC 102 and the server PC 104 will be described. The client PC 102 includes a print document entry unit 401, a print setting unit 402, a print job transmission unit 405, a prompt input unit 403, and a print instruction determination unit 404.

On the other hand, the server PC 104 includes a print setting generation unit 412. Furthermore, the print setting generation unit 412 includes a print document analysis unit 411 and a generative AI plugin 413. Furthermore, the generative AI plugin 413 includes a device information obtaining unit 414, a print setting generation model 415, and a generative AI 416.

The print document entry unit 401 of the client PC 102 obtains a print document. The print setting unit 402 specifies the print document and transmits the print document to the print setting generation unit 412 of the server PC 104 to request generation of print settings.

The print setting generation unit 412 of the server PC 104 generates print settings using the print document analysis unit 411 and the generative AI plugin 413. The print document analysis unit 411 analyzes data of the print document obtained by the print setting generation unit 412 and extracts a description regarding a print setting. For the extraction, for example, the generative AI 416 may be used, or a known text mining method may be used. The generative AI plugin 413 determines a print setting item corresponding to the extracted description regarding a print setting using the print setting generation model 415. The generative AI 416 generates an optimum setting value for each print setting item using, as input data, the print document or information related to the print document, the determined print setting items, and a prompt for instructing to generate an optimum setting value for each print setting item. The print setting generation model 415 interprets the generated optimum value and converts it into a corresponding print setting value.

Further, the device information obtaining unit 414 of the server PC 104 obtains and holds device information from the image output apparatus 100. The generative AI plugin 413 utilizes the held device information when outputting print settings using device information.

The print setting unit 402 of the client PC 102 obtains the print settings generated by the print setting generation unit 412 of the server PC 104 and makes a request for determination of the print settings to the print instruction determination unit 404. The print instruction determination unit 404 determines the print settings using, in addition to the generated print settings, print settings specified in advance in the client PC 102 and a print instruction in natural language input from the prompt input unit 403.

The print job transmission unit 405 of the client PC 102 creates a print job and transmits the created print job to the image output apparatus 100. When creating the print job, the print job transmission unit 405 combines the print settings determined by the print instruction determination unit 404 and the print image rendered by the CPU 300 of the client PC 102 as a print job.

Next, functional blocks of the image output apparatus 100 will be described. Note that description of functional blocks of the image output apparatus 101 is omitted because they are similar to functional blocks of the image output apparatus 100. The ROM 201 of the image output apparatus 100 includes a device information holding unit 406, a print job receiving unit 407, and a print executing unit 408.

The print job receiving unit 407 receives the print job transmitted from the client PC 102. The print executing unit 408 executes print processing for the print job. The device information holding unit 406 holds configuration and remaining amount information of consumables mounted in the image output apparatus 100, information on types and sizes of output paper, main body status information of the image output apparatus 100, and status information of a print job.

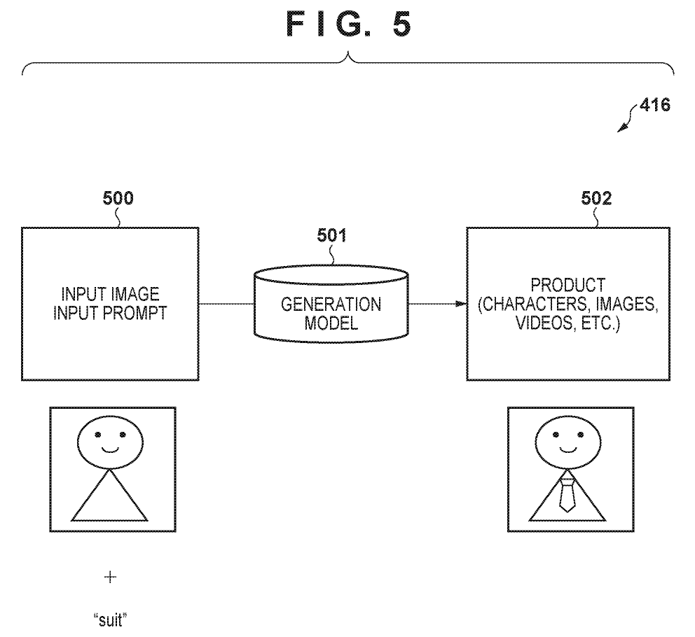

An overview of the generative AI 416 will be exemplified using FIG. 5. The generative AI 416 includes a generation model 501. The generation model 501 is, for example, Stable Diffusion (https://stability.ai/), ChatGPT (https://chat.openai.com/), GAN (Generative Adversarial Network), or the like. Note that the generation model 501 is not limited to these models.

The generative AI 416 can set images and text as input data 500 to be input to the generation model 501. The generation model 501 outputs, as output data 502, products such as characters, images, and videos with a high probability of matching a "context" expressed by the set input image or input prompt. The relationship between input values and "context" is acquired when a model learns using a large number of images and sentences. Further, when generating a product, it is possible to change the product by changing an initial value generated mainly from a random number.

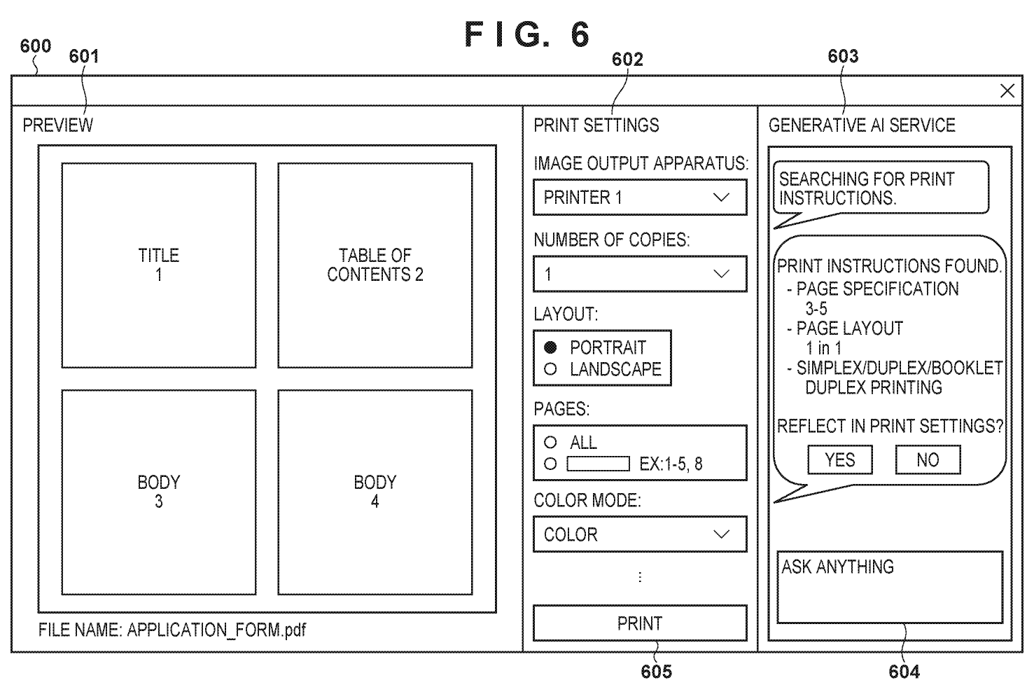

FIG. 6 exemplifies a document print screen 600 (an example of "a print setting screen") caused to be displayed on the display 309 by the print setting unit 402 of the client PC 102 using the display controller 305. The document print screen 600 is a screen targeting the image output apparatus 100. Note that FIG. 6 exemplifies the document print screen 600 in a case where an application form is accepted as a print document.

The document print screen 600 includes a print preview area 601, a print setting area 602, and a generative AI service area 603. In the print preview area 601, a print image as a result of performing rendering processing on the print document obtained by the print document entry unit 401 is displayed. In the print setting area 602, setting items that can be set by the print setting unit 402 are displayed. For example, in a case where a print instruction is described outside an entry field of the application form, the user can input settings according to the print instruction to a prompt input area 604 using the keyboard 308. The prompt input unit 403 accepts this input, and the print setting unit 402 displays the accepted input in the print setting area 602.

The generative AI service area 603 includes a prompt input area 604. The prompt input unit 403 obtains input information for the prompt input area 604 using the keyboard 308. Further, the print setting unit 402 displays, in the generative AI service area 603, prompts input by a user in the past and information generated by the print setting generation unit 412 for the prompts. The user can browse the information and select to reflect generated information.

When the print document entry unit 401 obtains a print document, the print setting unit 402 first displays a message "Searching for print instructions." in the generative AI service area 603 regardless of input. Thereafter, as described above, the print document analysis unit 411 of the print setting generation unit 412 of the server PC 104 extracts print instructions described in the print document. Then, the generative AI plugin 413 proposes print setting items and setting values thereof corresponding to the print instructions.

The print setting unit 402 of the client PC 102 displays the print settings output from the generative AI plugin 413 in this manner in the generative AI service area 603. Then, the print setting unit 402 accepts an input for reflecting the displayed print settings in the print job. In such a case, the print setting unit 402 updates the print preview and print setting values displayed in the print preview area 601 and the print setting area 602 according to the accepted input.

For example, the generative AI 416 outputs settings of page specification (pages 3-5), page layout (1in1), and simplex/duplex/booklet (duplex printing) of the server PC 104. The print setting unit 402 displays a message as to whether or not to reflect these settings in the print settings. Then, in a case where the print setting unit 402 accepts an input indicating that they are to be reflected, the print setting unit 402 changes the print image displayed in the print preview area 601 to images of pages 3-5 and displays them.

Further, the print setting unit 402 displays the print image in a format according to 1in1 and duplex printing. Further, although not shown, the print setting unit 402 changes and displays the value of the page setting item in the print setting area 602 to "3-5", the page layout setting item to "1in1", and the setting item of simplex/duplex/booklet to "duplex printing". Note that the print setting unit 402 may automatically reflect the print settings output from the generative AI plugin 413 in the print settings without displaying information regarding whether or not to reflect them in the print settings in the generative AI service area 603.

Further, the print setting unit 402 can obtain setting input for the print setting area 602 in addition to the automatically reflected print settings. Further, the print setting unit 402 can also obtain input of print settings in natural language in the prompt input area 604 of the generative AI service area 603 accepted by the prompt input unit 403. If the print settings obtained at this time contradict a print instruction of the print document, the print setting unit 402 may display a message to that effect or information about whether or not to reflect the print instruction of the print document again.

Further, the print settings proposed by the generative AI plugin 413 when the print document entry unit 401 obtains the print document may be values that take into account device information such as feed paper and remaining amounts of consumables of the image output apparatus 100. For example, in a case where a print instruction in a color mode is not particularly described in the print document, the generative AI plugin 413 may propose monochrome printing.

In addition, the generative AI plugin 413 may notify that printing cannot be performed according to the print instruction described in the print document in a case where feed paper is not compatible with duplex printing or the like. Furthermore, the generative AI plugin 413 may include instructions to be executed after print processing, such as stapling or stamping, in the proposal of print settings. In such a case, the user is prevented from overlooking instructions for after print processing. Further, the generative AI plugin 413 may include a recommended image output apparatus in the proposal of print settings, and may make a proposal of print settings for urging printing with an image output apparatus capable of reflecting all items of the proposed print settings.

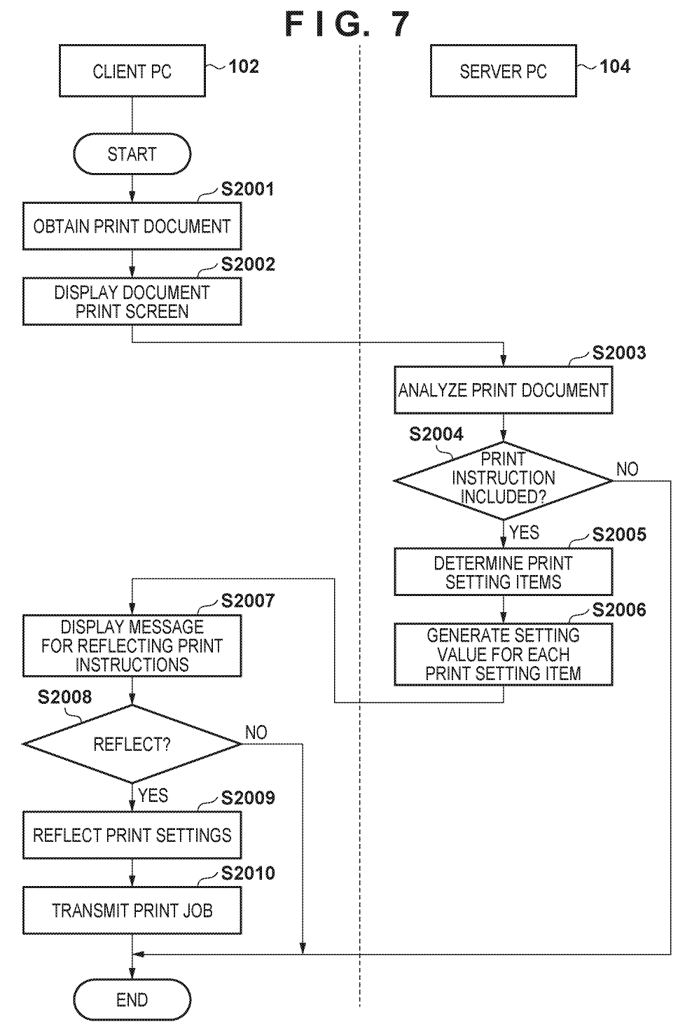

A processing flow in which print settings generated by generative AI are reflected in the document print screen 600 will be exemplified using FIG. 7. This flow is started, for example, triggered by the print document entry unit 401 of the client PC 102 receiving a print document. Note that the flowchart shown in FIG. 7 is realized, for example, by the respective CPUs of the client PC 102 and the server PC 104 reading out programs stored in ROM into RAM and executing them.

In step S2001, the print setting unit 402 of the client PC 102 obtains the print document accepted by the print document entry unit 401. In step S2002, the print setting unit 402 displays the document print screen 600 on the display 309. At this time, the print setting unit 402 displays a message "Searching for print instructions." in the generative AI service area 603. Further, the print setting unit 402 transmits the print document accepted in step S2001 to the print setting generation unit 412 of the server PC 104 using a communication module, and requests generation processing of print setting values. Then, the print setting generation unit 412 of the server PC 104 receives this request using a communication module.

In step S2003, the print setting generation unit 412 of the server PC 104 makes as request for analysis of the print document to the print document analysis unit 411. The print document analysis unit 411 (an example of "an extraction unit") analyzes the print document in response to this request and extracts a description regarding a print setting. Note that when the print setting unit 402 makes a request for the generation processing of print setting values to the print setting generation unit 412 in step S2002, the print setting unit 402 may send to the print setting generation unit 412 information related to the print document separate from the print document in step S2001. Then, in step S2003, the print document analysis unit 411 may include this related information in an analysis target. The information related to the print document is, for example, a document obtained at the same timing as the timing when the print setting unit 402 obtained the print document, or a URL of a site from which the print document was obtained.

In step S2004, the print document analysis unit 411 (an example of "a determination unit") analyzes the extracted description regarding a print setting and determines whether or not a print instruction is described in the print document. Then, in a case where the print document analysis unit 411 determines that a print instruction is described, the processing proceeds to step S2005, and otherwise, the processing ends.

Note that in a case where the print document analysis unit 411 determines that a print instruction is not described, the print setting generation unit 412 may transmit a message to that effect to the client PC 102. Then, the print setting unit 402 of the client PC may receive this message and display a message "There were no print instructions in the print document." in the generative AI service area 603 of the document print screen 600. Alternatively, the print setting unit 402 may set print setting values to default values of a driver of the image output apparatus (100, 101) when receiving this message.

In step S2005, the generative AI plugin 413 of the server PC 104 determines print setting items related to the description regarding a print setting extracted by the print document analysis unit 411 using the print setting generation model 415.

In step S2006, the generative AI plugin 413 inputs, to the generative AI 416 as input data, the print document or information related to the print document, the determined print setting items, and a prompt for instructing generation of an optimum setting value for each print setting item. Then, the generative AI 416 generates the setting values. Then, the generative AI plugin 413 drops the generated setting values into values that can be set for the print setting items using the print setting generation model 415.

For example, it is assumed that the generative AI 416 generates print setting values of "color printing/booklet printing". However, it is assumed that the image output apparatus 100 is a monochrome-only printer. In such a case, the print setting generation model 415 changes the print setting values to setting values suitable for the image output apparatus 100, such as "monochrome/stapling".

In another example, it is assumed that the generative AI 416 generates print setting values with a sentence such as "Please add a print mode with high print quality and durability." In such a case, the print setting generation model 415 changes the print setting values to specific setting values such as "Quality = High quality, Feed paper = Matte paper". Note that a sentence such as "Please add a print mode with high print quality and durability" is an example of "a sentence indicating a print setting item".

Then, the print setting generation unit 412 transmits the print setting values thus generated to the client PC 102. Then, the print setting unit 402 of the client PC 102 receives the print setting values.

In step S2007, the print setting unit 402 of the client PC 102 displays the setting values (step S2006) set for each determined print setting item (step S2005) in the generative AI service area 603 of the document print screen 600 as shown in FIG. 6. Further, the print setting unit 402 (an example of "a display unit") displays a message asking whether or not to reflect the setting values in the print setting values. At this time, in a case where the setting values are changed as mentioned in the example of step S2006, the print setting unit 402 may display a message such as "Actually, color printing/booklet printing is specified, but it can only be changed to monochrome/stapling. Do you want to reflect it?".

In step S2008, the print setting unit 402 determines whether or not there has been an input for selecting to reflect the values in relation to the message displayed in step S2007. Then, in a case where the print setting unit 402 (an example of "an accepting unit") determines that there has been an input for selecting to reflect the values, the print setting unit 402 accepts this input and processing proceeds to step S2009, and otherwise, the processing ends.

In step S2009, the print instruction determination unit 404 determines the setting values set in step S2006 as the print setting values for each print setting item determined in step S2005. Then, the print setting unit 402 displays the determined print settings in the print setting area 602 of the document print screen 600. Note that the print setting values generated in step S2006 may include not only characters but also a group of images extracting specified information in the document.

In step S2010, the print job transmission unit 405 of the client PC 102 creates a print job including the print setting values determined in step S2009 and the print image obtained by rendering the print document. Then, the print job transmission unit 405 transmits this print job to, for example, the image output apparatus 100. Then, the processing ends. In the image output apparatus 100, the print job receiving unit 407 receives this print job. Then, the print executing unit 408 executes this print job.

### One Aspect of Functions/Effects

According to the information processing system 10 as described above, descriptions regarding a print setting described in a print document are automatically extracted. Furthermore, according to the information processing system 10, print settings corresponding to a print document are generated from the extracted description regarding a print setting using generative AI. Therefore, a user does not need to prepare print settings for each print attribute in advance. Further, since the user does not need to find a print instruction described in the print document, overlooking of the print instruction can be suppressed. According to such an information processing system 10, a print instruction described in a print document can be easily and reliably reflected in print settings.

### First Modification

In the embodiment described above, the print setting generation unit 412 generated print settings from print instructions described in a document using the print document analysis unit 411 and the generative AI plugin 413. Then, the generated print settings were reflected in the entire document. However, depending on a print document, a print instruction may be described for each page.

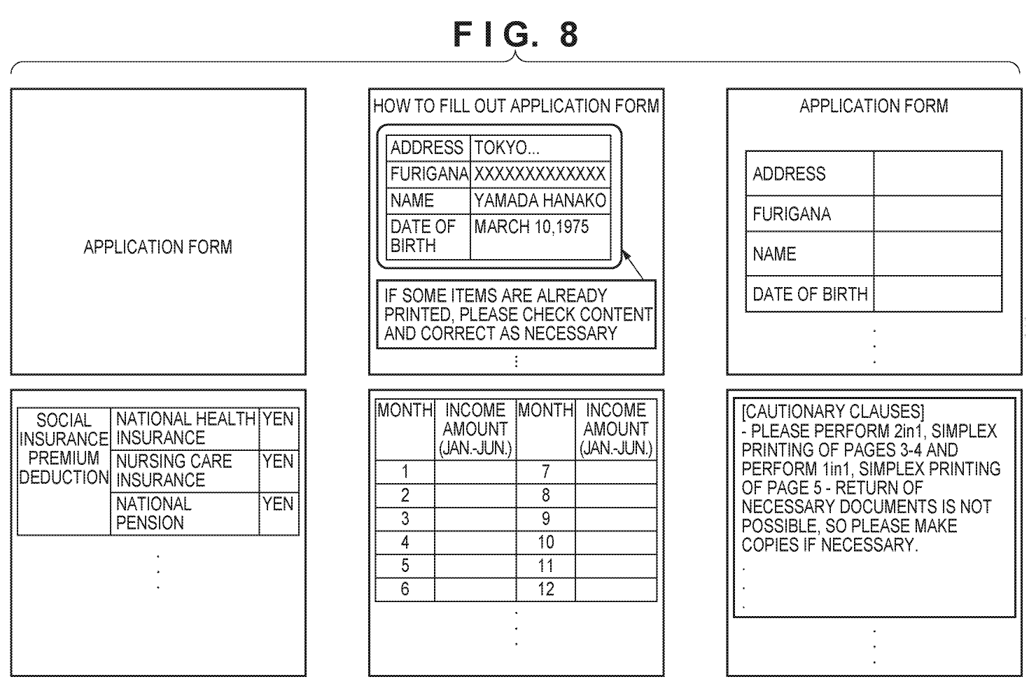

FIG. 8 exemplifies such an application form. For example, in an application form as shown in FIG. 8, it is described in a column of cautionary clauses on the sixth page: "Please perform 2in1, simplex printing of pages 3-4 and perform 1in1, simplex printing of page 5." In such a case, print settings are performed twice separately. That is, the first print settings are settings for the page setting item "3-4", the page layout setting item "2in1", and the setting item of simplex/duplex/booklet "simplex printing". The second print settings are settings for the page setting item "5", the page layout setting item "1in1", and the setting item of simplex/duplex/booklet "simplex printing". In a case where a plurality of print settings are necessary in this manner, a plurality of messages for reflecting print instructions are displayed in the generative AI service area 603.

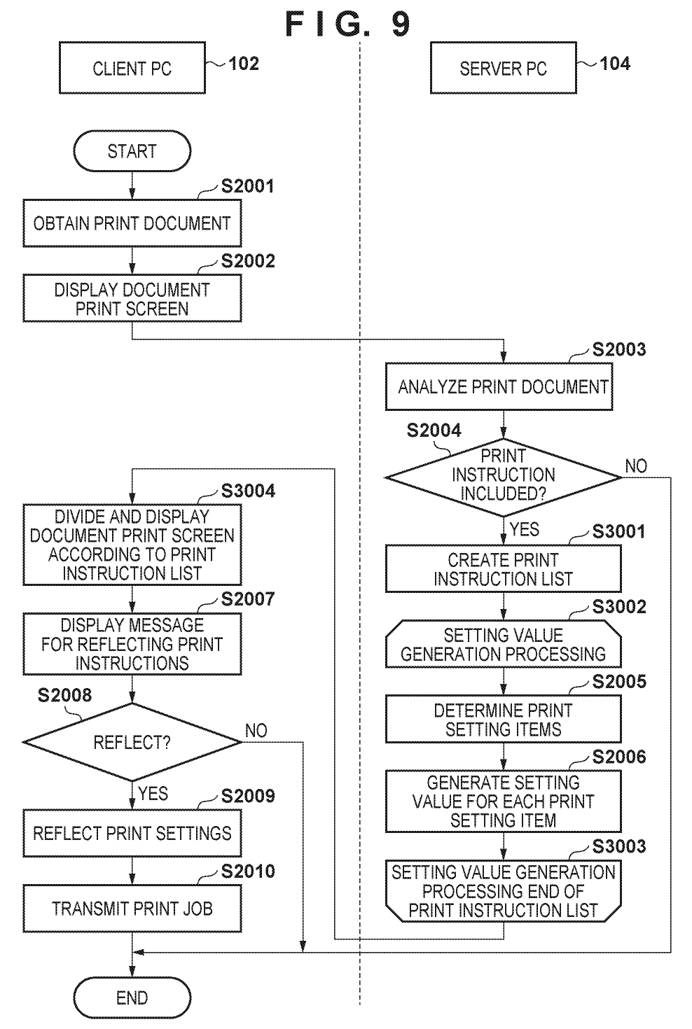

A processing flow for reflecting a plurality of print settings generated by generative AI in the document print screen 600 will be described using FIG. 9. This processing flow is started, for example, triggered by the print document entry unit 401 of the client PC 102 receiving a print document. Note that the flowchart shown in FIG. 9 is realized, for example, by the respective CPUs of the client PC 102 and the server PC 104 reading out programs stored in ROM into RAM and executing them.

Steps S2001 to S2004 shown in FIG. 9 are similar to steps S2001 to S2004 in FIG. 7 according to the embodiment, and thus description thereof is omitted. In FIG. 9, in step S2004, in a case where the print document analysis unit 411 determines that a print instruction is described, processing proceeds to step S3001. In step S3001, the print document analysis unit 411 of the server PC 104 creates a print instruction list according to the number of descriptions regarding a print setting extracted in step S2003.

For example, as shown in FIG. 8, in a case where it is described in the column of cautionary clauses in the application form: "Please perform 2in1, simplex printing of pages 3-4 and perform 1in1, simplex printing of page 5.", the following processing is executed. For example, the print document analysis unit 411 creates a print instruction list including "pages 3-4 with settings of the page layout setting item '2in1' and the setting item of simplex/duplex/booklet 'simplex printing'". Further, the print document analysis unit 411 creates a print instruction list including "page 5 with the page layout setting item '1in1' and the setting item of simplex/duplex/booklet 'simplex printing'". Thereafter, the processing proceeds to step S3002.

In steps S3002, S2005, S2006, and S3003, generation processing of print setting values in steps S2005 and S2006 shown in FIG. 7 is repeatedly executed for the number of entries in the print instruction list. Further, in step S2006 shown in FIG. 9, the print setting generation unit 412 transmits the print instruction list to the client PC 102. Then, the print setting unit 402 of the client PC 102 receives this print instruction list. Thereafter, the processing proceeds to step S3004.

In step S3004, the print setting unit 402 divides and displays the document print screen 600 according to the number of entries in the print instruction list. Thereafter, the processing proceeds to step S2007. Steps S2007 to S2010 are similar to steps S2007 to S2010 in FIG. 7. However, in step S2010 according to the first modification, by operating each of the divided document print screens 600, a print job corresponding to each image is transmitted to the image output apparatus.

Note that in step S3004, the print setting unit 402 may display a message as to whether or not to reflect print settings for each of a plurality of print instruction lists in the generative AI service area 603 of one document print screen 600. Then, the print setting unit 402 may accept an input for selecting to reflect the settings for each message. Then, the print setting unit 402 may reflect setting values set in step S2006 in the document print screen 600 for each accepted input. Then, the processing ends.

### One Aspect of Functions/Effects

According to the information processing system 10 according to the first modification, even in a case where a plurality of print instructions are described in a print document, the print instructions described in the print document can be easily and reliably reflected in print settings.

### Second Modification

In the embodiment described above, a layout data creation application is cited as an example of an application, but the embodiment is not limited to this example and can be realized by and is effective for any application having a similar image layout function.

Further, any information processing apparatus may be adopted as a substitute for the client PC 102. The information processing apparatus is, for example, a mobile phone, a personal digital assistant, a digital still camera, a digital video camera, a portable music player, a game apparatus, a set-top box, an Internet home appliance, or the like.

Further, in the embodiment described above, Ethernet is exemplified as a configuration example of the network 103, but the embodiment is not limited to this example. For example, the network 103 may have any other network configuration such as a wireless LAN, IEEE 1394, or Bluetooth.

### Other Modifications

The generative AI plugin 413 may detect an original size or a font size or the like from data of a print document, and input a prompt for instructing to generate an optimum print setting value using these pieces of detected information to the generative AI 416. Further, the print setting generation model 415 may determine which apparatus among the plurality of image output apparatuses (100, 101) is to execute a print job according to the description regarding a print setting extracted by the print document analysis unit 411. Then, the print setting generation model 415 may transmit information of the determined image output apparatus to the client PC 102.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025- 080610, filed May 13, 2025, which is hereby incorporated by reference herein in its entirety.

What is claimed is:

1. An information processing apparatus comprising:
one or more memory devices that store a set of instructions; and
one or more processors that execute the set of instructions to:
obtain a document to be printed;
extract a description regarding a print setting from the obtained document to be printed or information related to the document to be printed;
determine a print setting item using the extracted description regarding a print setting; and
generate a setting value for the determined print setting item using generative AI.

2. The information processing apparatus according to claim 1, wherein
the information related to the document to be printed includes another document obtained when the document to be printed was obtained, or a URL of a source from which the document to be printed was obtained.

3. The information processing apparatus according to claim 1, wherein
the one or more processors execute instructions in the one or more memory devices to:
determine whether or not a print instruction is included in the extracted description regarding a print setting; and
determine the print setting item in a case where it is determined that the print instruction is included.

4. The information processing apparatus according to claim 1, wherein
generating the setting value includes generating the setting value according to device information of an image output apparatus that prints the document to be printed.

5. The information processing apparatus according to claim 1, wherein
generating the setting value includes generating a setting value for each print setting item from a sentence indicating a print setting item among the description regarding a print setting.

6. The information processing apparatus according to claim 1, wherein
the one or more processors execute instructions in the one or more memory devices to:
in a case where there are a plurality of extracted descriptions regarding a print setting,
determine a print setting item for each of the plurality of descriptions regarding a print setting; and
generate the setting value for the print setting item for each of the plurality of descriptions regarding a print setting.

7. The information processing apparatus according to claim 6, wherein
the plurality of descriptions regarding a print setting include descriptions regarding a print setting that differ for each page.

8. The information processing apparatus according to claim 1, wherein
the one or more processors execute instructions in the one or more memory devices to:
input the document to be printed or information related to the document to be printed, the print setting item, and a prompt for instructing generation of a setting value corresponding to the print setting item as input data into the generative AI.

9. An information processing system comprising:
the information processing apparatus according to claim 1; and
another information processing apparatus, wherein
in the information processing apparatus, the one or more processors further execute instructions in the one or more memory devices to:
output the generated setting value to the other information processing apparatus, and
the other information processing apparatus comprising:
one or more memory devices that store a set of instructions; and
one or more processors that execute the set of instructions to:
obtain the setting value output by the information processing apparatus;
display a print setting screen including a print preview of the document to be printed, a print setting of the document to be printed, and a message as to whether or not to reflect the obtained setting value in the print setting; and
accept an input for indicating that the setting value is to be reflected in the print setting with respect to the message, wherein
in the other information processing apparatus, the one or more processors execute instructions in the one or more memory devices to:
reflect the setting value in the print setting and display them when the input is accepted.

10. The information processing system according to claim 9, wherein
in the other information processing apparatus, the one or more processors execute instructions in the one or more memory devices to:
in a case where there are a plurality of extracted descriptions regarding a print setting, display the message for each of the plurality of descriptions regarding a print setting; and
accept the input for each of the plurality of messages.

11. The information processing system according to claim 9, wherein
in the other information processing apparatus, the one or more processors execute instructions in the one or more memory devices to:
in a case where there are a plurality of extracted descriptions regarding a print setting, display the print setting screen for each of the plurality of descriptions regarding a print setting.

12. The information processing system according to claim 9, wherein
in the other information processing apparatus, the one or more processors further execute instructions in the one or more memory devices to:
display a message indicating that the description regarding a print setting cannot be reflected in the print setting.

13. The information processing system according to claim 9, wherein
in the other information processing apparatus, the one or more processors further execute instructions in the one or more memory devices to:
accept a prompt regarding the print setting.

14. A method for controlling an information processing apparatus comprising:
obtaining a document to be printed;
extracting a description regarding a print setting from the obtained document to be printed or information related to the document to be printed;
determining a print setting item using the extracted description regarding a print setting; and
generating a setting value for the determined print setting item using generative AI.

15. A method for controlling an information processing system including the information processing apparatus according to claim 1 and another information processing apparatus, comprising:
in the information processing apparatus,
obtaining a document to be printed;
extracting a description regarding a print setting from the obtained document to be printed or information related to the document to be printed;
determining a print setting item using the extracted description regarding a print setting;
generating a setting value for the determined print setting item using generative AI; and
outputting the generated setting value to the other information processing apparatus; and
in the other information processing apparatus,
obtaining the setting value output by the information processing apparatus;
displaying a print setting screen including a print preview of the document to be printed, a print setting of the document to be printed, and a message as to whether or not to reflect the obtained setting value in the print setting; and
accepting an input for indicating that the setting value is to be reflected in the print setting with respect to the message, wherein
the setting value is reflected in the print setting and displayed when the input is accepted.

16. A non-transitory computer-readable storage medium storing a computer program for causing a computer to execute each step in a method for controlling an information processing apparatus, the method comprising:
obtaining a document to be printed;
extracting a description regarding a print setting from the obtained document to be printed or information related to the document to be printed;
determining a print setting item using the extracted description regarding a print setting; and
generating a setting value for the determined print setting item using generative AI.
